(19) United States
(12) Patent Application Publication
(10) Pub. No.: US 2023/0130023 A1
(43) Pub. Date: Apr. 27, 2023

(54) INFORMATION PROCESSING APPARATUS, PRODUCT RECOMMENDATION SYSTEM, AND NON-TRANSITORY COMPUTER READABLE MEDIUM STORING PROGRAM

(71) Applicant: FUJIFILM Business Innovation Corp., Tokyo (JP)

(72) Inventor: Toru IZUMIYA, Kanagawa (JP)

(73) Assignee: FUJIFILM Business Innovation Corp., Tokyo (JP)

(21) Appl. No.: 17/741,473

(22) Filed: May 11, 2022

(30) Foreign Application Priority Data
Oct. 21, 2021 (JP) 2021-172337

(51) Int. Cl. G06Q 30/02; G06Q 30/06

(52) U.S. Cl. CPC G06Q 30/0281; G06Q 30/0631

(57) ABSTRACT

An information processing apparatus includes a processor configured to specify, using information regarding a product selected as a purchase target by an in-store customer who visits a store and a movement flow line of the in-store customer in the store, a recommended product to be recommended to the in-store customer from among products displayed at a place not looked by the in-store customer in the store.

### CROSS-REFERENCE TO RELATED APPLICATIONS

This application is based on and claims priority under 35 USC 119 from Japanese Patent Application No. 2021-172337 filed Oct. 21, 2021.

### BACKGROUND

### (i) Technical Field

The present invention relates to an information processing apparatus, a product recommendation system, and a non-transitory computer readable medium storing a program.

### (ii) Related Art

JP2002-279279A discloses a technique that, in a case where a customer purchases a certain product, recommends a product to the customer in consideration of a time-series order relationship regarding product purchase.

JP2008-511066A discloses a technique that detects and tracks a position of a customer in a store using a radio frequency identification (RFID), thereby analyzing a flow line of shopping of the customer.

### SUMMARY

In recommending a product to an in-store customer who visits a store or the like that sells products, in a case where a product to be recommended is specified without using a movement flow line of the in-store customer, a product or the like determined to be looked and not purchased previously by the in-store customer may be recommended. In this case, recommendation of a product hardly results in product purchase of a customer.

Aspects of non-limiting embodiments of the present disclosure relate to an information processing apparatus, a product recommendation system, and a non-transitory computer readable medium storing a program that specify a product highly likely to be purchased by an in-store customer as a recommended product to be recommended to the in-store customer compared to a case where a movement flow line of the in-store customer in a store is not used.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including a processor configured to specify, using information regarding a product selected as a purchase target by an in-store customer who visits a store and a movement flow line of the in-store customer in the store, a recommended product to be recommended to the in-store customer from among products displayed at a place not looked by the in-store customer in the store.

### BRIEF DESCRIPTION OF THE DRAWINGS

Exemplary embodiment(s) of the present invention will be described in detail based on the following figures, wherein:

FIG. 1 is a diagram showing an example of the overall configuration of a product recommendation system 1 to which the present exemplary embodiment is applied;

FIG. 2 is a diagram showing the hardware configuration of an information processing apparatus;

FIG. 3 is a block diagram showing an example of a functional configuration that is realized by the information processing apparatus to which the present exemplary embodiment is applied;

FIG. 4 is a flowchart illustrating an example of processing by a purchase product prediction unit of the information processing apparatus to which the present exemplary embodiment is applied;

FIG. 5 is a flowchart illustrating an example of processing of a behavior prediction unit of the information processing apparatus to which the present exemplary embodiment is applied;

FIG. 6 is a flowchart illustrating an example of processing of a recommended product decision unit of the information processing apparatus to which the present exemplary embodiment is applied;

FIG. 7 is a diagram showing an example of a store where the information processing apparatus recommends a product to a customer;

FIG. 8 is a diagram showing an example of sales information that is stored in a sales information DB and is acquired by the purchase product prediction unit;

FIG. 9 is a diagram showing an example of position information of simultaneous purchase products that are acquired from a product position information DB by the purchase product prediction unit;

FIG. 10 shows an example of a prediction result of a behavior of a target customer in a case where a purchase-expected product is recommended to the target customer, output from a learning model; and

FIG. 11 is a diagram showing a relationship between position information in a store of a recommendation candidate product and a current position of a target customer.

### DETAILED DESCRIPTION

Hereinafter, an exemplary embodiment of the invention will be described referring to the accompanying drawings.

### Exemplary Embodiment 1

Information Processing System 1

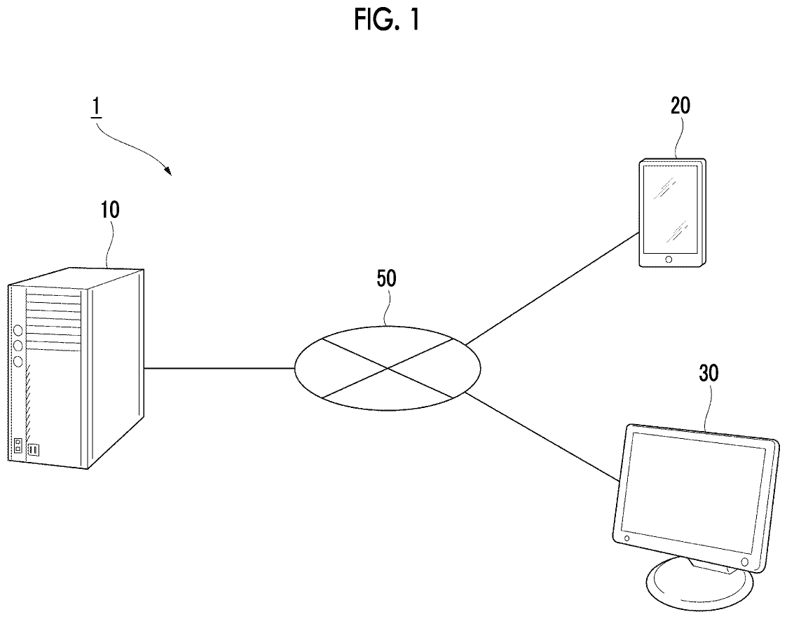

FIG. 1 is a diagram showing an example of the overall configuration of a product recommendation system 1 to which the present exemplary embodiment is applied. The product recommendation system 1 is used to recommend products displayed in a store to an in-store customer who visits the store.

As shown in FIG. 1, the product recommendation system 1 includes an information processing apparatus 10, a terminal apparatus 20, and a display 30. In the product recommendation system 1, the information processing apparatus 10, the terminal apparatus 20, and the display 30 are connected via a communication line 50, such as an Internet line. Although product recommendation system 1 of FIG. 1 includes one information processing apparatus 10, one single terminal apparatus 20, and one display 30, these apparatuses may be plural.

The terminal apparatus 20 is an apparatus that is carried with and operated by the in-store customer or the like who visits the store, and is, for example, a portable information terminal, such as a smartphone. Though not shown, the terminal apparatus 20 has a central processing unit (CPU), a read only memory (ROM), and a random access memory (RAM). The ROM stores a control program that is executed by the CPU. Then, the CPU reads out the control program stored in the ROM and executes the control program with the RAM as a work area.

The terminal apparatus 20 includes display means for displaying information received from the information processing apparatus 10 or the like, such as a liquid crystal display or an organic EL display.

The display 30 is installed in the store and displays information to the in-store customer who visits the store. The display 30 is configured of a liquid crystal display, an organic EL display, or the like.

Information Processing Apparatus 10

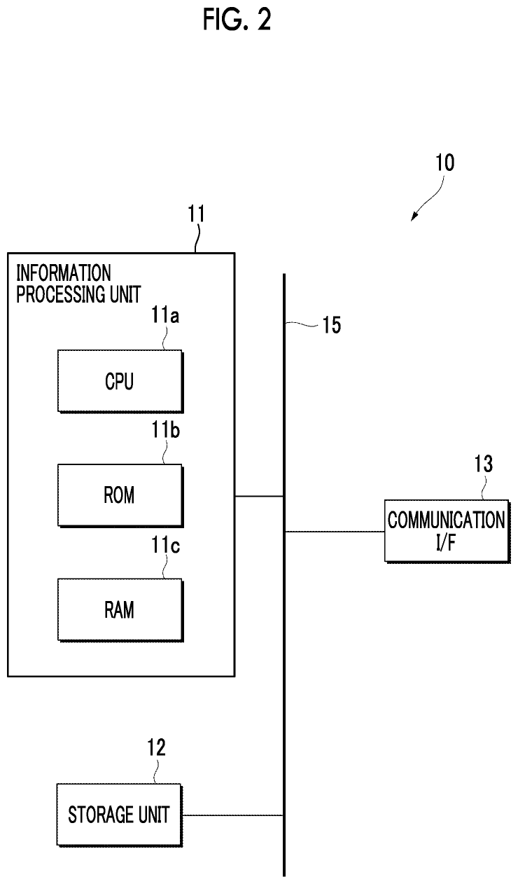

Subsequently, the hardware configuration of the information processing apparatus 10 to which the present exemplary embodiment is applied will be described. FIG. 2 is a diagram showing an example of the hardware configuration of the information processing apparatus 10.

As shown in FIG. 2, the information processing apparatus 10 includes an information processing unit 11 that processes information, a storage unit 12 that is configured of a hard disk drive (HDD) or the like and stores information, and a communication interface (communication I/F) 13 that realizes communication. In the information processing apparatus 10, the information processing unit 11, the storage unit 12, and the communication I/F 13 are connected to a bus 15 and perform transfer of data via the bus 15.

As shown in FIG. 2, the information processing unit 11 is configured of a central processing unit (CPU) 11a, a read only memory (ROM) 11b, a random access memory (RAM) 11c.

The CPU 11a is an example of a processor, and realizes each function described below by loading various programs stored in the ROM 11b or the like to the RAM 11c and executing the programs. The RAM 11c is a memory that is used as a work memory or the like of the CPU 11a. The ROM 11b is a memory that stores various programs and the like to be executed by the CPU 11a.

Here, the programs that are executed by the CPU 11a can be provided to the information processing apparatus 10 in a state of being stored in a computer readable recording medium, such as a magnetic recording medium (magnetic tape, magnetic disk, or the like), an optical recording medium (optical disc or the like), a magneto-optical recording medium, or a semiconductor memory. The programs that are executed by the CPU 11a may be provided to the information processing apparatus 10 using communication means, such as the Internet.

In the embodiments above, the term “processor” refers to hardware in abroad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device).

In the embodiments above, the term “processor” is broad enough to encompass one processor or plural processors in collaboration which are located physically apart from each other but may work cooperatively. The order of operations of the processor is not limited to one described in the embodiments above, and may be changed.

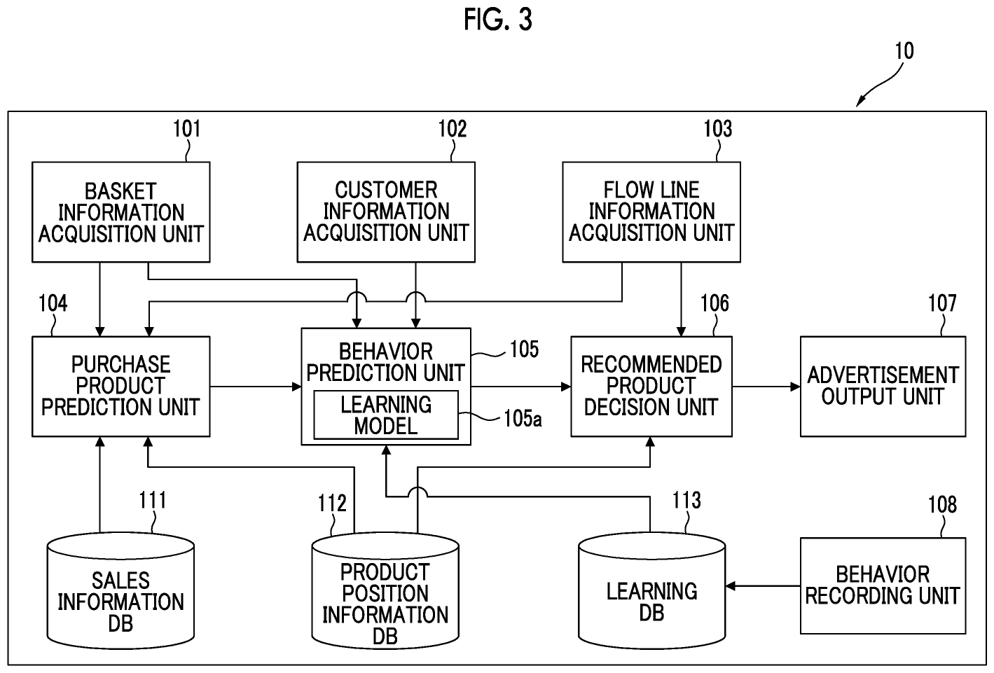

Subsequently, a functional configuration that is realized by the information processing apparatus 10 will be described. FIG. 3 is a block diagram showing an example of a functional configuration that is realized by the information processing apparatus 10 to which the present exemplary embodiment is applied. Each function of the information processing apparatus 10 shown in FIG. 3 is mostly realized by the CPU 11a of the information processing unit 11.

As shown in FIG. 3, the information processing apparatus 10 includes a basket information acquisition unit 101, a customer information acquisition unit 102, a flow line information acquisition unit 103, a purchase product prediction unit 104, a behavior prediction unit 105, a recommended product decision unit 106, an advertisement output unit 107, and a behavior recording unit 108. The information processing apparatus 10 also includes a sales information database (DB) 111, a product position information DB 112, and a learning DB 113.

The basket information acquisition unit 101 acquires information regarding a product put into a shopping basket by an in-store customer who visits a store. In this example, information regarding the product put into the shopping basket by the in-store customer who visits the store is an example of information regarding a product selected as a purchase target by a customer who visits a store. In the following description, information regarding the product put into the shopping basket by the customer who visits the store, acquired by the basket information acquisition unit 101 may be described as shopping basket information. In the following description, the in-store customer who visits the store and is a target of acquisition of the shopping basket information by the basket information acquisition unit 101 may be described as a target customer.

The basket information acquisition unit 101 acquires information for identifying the product put into the shopping basket by the target customer, as the shopping basket information. Examples of such information for identifying a product include information regarding a name (product name) of a product or a model number of a product. The basket information acquisition unit 101 may also acquire information regarding the number of products put into the shopping basket or the size of a product as the shopping basket information. The basket information acquisition unit 101 may also acquire information regarding a time at which a product is put into the shopping basket or an order in which products are put into the shopping basket, as the shopping basket information.

The basket information acquisition unit 101 recognizes a product put into the shopping basket by the target customer based on, for example, a video imaged by imaging means, such as a camera installed in the store, and acquires the shopping basket information.

The basket information acquisition unit 101 may acquire the shopping basket information using radio frequency identifier (RFID). Specifically, an RF tag is attached to a product displayed in the store, and the RF tag of the product is scanned with a scanner installed in the store or the shopping basket. The basket information acquisition unit 101 recognizes the product put into the shopping basket by the target customer based on a scanning result of the RF tag by the scanner and acquires the shopping basket information.

A method by which the basket information acquisition unit 101 acquires the shopping basket information is not limited to the above-described method as long as the product put into the shopping basket by the target customer can be recognized.

The customer information acquisition unit 102 acquires information regarding a customer (target customer) who selects a product displayed in the store as a purchase target. In this example, the customer information acquisition unit 102 acquires information regarding a customer who puts a product into the shopping basket, as the customer who selects the product displayed in the store as the purchase target. In the following description, information regarding the target customer acquired by the customer information acquisition unit 102 may be described as customer information.

Examples of the customer information acquired by the customer information acquisition unit 102 include, but are not limited to, for example, a sex, an age, a family make-up, a visit frequency to a store, a purchase amount in a case of visiting a store in the past, means of transportation to a store, and a required time to a store of the target customer.

The customer information acquisition unit 102 can acquire the customer information, for example, via the terminal apparatus 20 that is used by the target customer. In addition, the customer information acquisition unit 102 causes the target customer to input the customer information via the terminal apparatus 20 and acquires the customer information input from the target customer via the communication line 50.

The customer information acquisition unit 102 may recognize the target customer based on a video imaged by the imaging means, such as a camera installed in the store, and may acquire the customer information.

A method by which the customer information acquisition unit 102 acquires the customer information is not limited to the above-described method.

The flow line information acquisition unit 103 acquires information regarding a movement flow line of the target customer in the store. Here, the movement flow line is a locus of movement in the store of the target customer who visits the store.

The flow line information acquisition unit 103 collects, for example, position information of the target customer in the store at a predetermined timing and acquires the movement flow line of the target customer based on the collected position information. The flow line information acquisition unit 103 acquires latest position information among the collected position information as a current position of the target customer in the store.

The flow line information acquisition unit 103 acquires the position information or the movement flow line of the target customer in the store based on a video imaged by the imaging means, such as a camera installed in the store.

The flow line information acquisition unit 103 may acquire the position information or the movement flow line of the target customer in the store using RFID. Specifically, an RF tag is attached to the shopping basket, a shopping cart, or the like that is used by the target customer, and the RF tag of the shopping basket, the shopping cart, or the like is scanned with the scanner installed in the store. The flow line information acquisition unit 103 acquires the position information or the movement flow line of the target customer in the store based on a scanning result of the RF tag by the scanner.

Besides, the flow line information acquisition unit 103 may acquire the position information or the movement flow line of the target customer in the store by a beacon technique or the like using a Bluetooth (Registered Trademark) signal sent from the terminal apparatus 20.

A method by which the flow line information acquisition unit 103 acquires the position information or the movement flow line of the target customer in the store is not limited to the above-described method.

The purchase product prediction unit 104 predicts a product likely to be purchased by the target customer who visits the store. Specifically, the purchase product prediction unit 104 predicts the product likely to be purchased by the target customer who visits the store, based on the shopping basket information acquired by the basket information acquisition unit 101, the customer information acquired by the customer information acquisition unit 102, the movement flow line of the target customer acquired by the flow line information acquisition unit 103, information regarding sales of the products in the store stored in the sales information DB 111, and the position information of the products in the store stored in the product position information DB 112. In the present exemplary embodiment, the purchase product prediction unit 104 predicts the product likely to be purchased by the target customer from products displayed at a place not looked by the target customer in the store. In the following description, the product that the purchase product prediction unit 104 predicts to be likely to be purchased by the target customer may be described as a purchase-expected product.

The processing of predicting the product likely to be purchased by the target customer with the purchase product prediction unit 104 will be described in a later section in detail.

The behavior prediction unit 105 predicts a behavior of the target customer using a learning model 105a in a case where the purchase-expected product predicted by the purchase product prediction unit 104 is recommended to the target customer, based on the shopping basket information acquired by the basket information acquisition unit 101 and the customer information acquired by the customer information acquisition unit 102. In the description of the present exemplary embodiment, the expression “recommend a product to a customer” means that the customer is recommended to purchase the product, and in this example, means that the customer is recommended to purchase the product by presenting advertisement regarding the product to the customer.

Here, the learning model 105a that is used in prediction of a behavior by the behavior prediction unit 105 is a learning model that, in a case where another product displayed in the store is recommended to a customer who puts a certain product from among the products displayed in the store into the shopping basket, learns a behavior of the customer. As described below, learning data that is a past leaning result learned by the learning model 105a is stored in the learning DB 113.

The learning model 105a of the present exemplary embodiment has, as input data, the shopping basket information acquired by the basket information acquisition unit 101, the customer information acquired by the customer information acquisition unit 102, and information regarding the purchase-expected product predicted by the purchase product prediction unit 104. Then, the learning model 105a outputs, as output data, a classification of a behavior to be predicted of the target customer in a case where the purchase-expected product is recommended to the target customer, based on the input data and the learning data stored in the learning DB 113.

The processing in which the behavior prediction unit 105 predicts the behavior of the target customer using the learning model 105a will be described in a later section in detail.

The recommended product decision unit 106 decides a product to be recommended to the target customer based on a prediction result of the behavior of the target customer by the behavior prediction unit 105, the current position of the target customer in the store acquired by the flow line information acquisition unit 103, and the position information of the products in the store stored in the product position information DB 112.

The recommended product decision unit 106 decides, as the product to be recommended to the target customer, a product that is predicted to be purchased as the behavior of the target customer in a case where the product is recommended to the target customer, with the behavior prediction unit 105 and is near the current position of the target customer. In the following description, the product to be recommended to the target customer, decided by the recommended product decision unit 106 may be described as a recommended product.

The processing of deciding the recommended product with the recommended product decision unit 106 will be described in a later section in detail.

The advertisement output unit 107 outputs an advertisement on the recommended product decided by the recommended product decision unit 106 to the terminal apparatus 20 or the display 30. In addition, the advertisement output unit 107 outputs an advertisement for recommending the target customer to purchase the recommended product to the terminal apparatus 20 or the display 30.

The behavior recording unit 108 acquires a behavior result of the target customer who receives the recommendation for the recommended product, based on the advertisement output from the advertisement output unit 107. Then, the behavior recording unit 108 stores the behavior result of the target customer as training data of the learning model 105a in the learning DB 113. In other words, the behavior recording unit 108 makes the learning model 105a learn the behavior result of the target customer in a case where the recommended product is recommended, as training data.

The behavior recording unit 108 may also store the shopping basket information of the target customer and the customer information of the target customer in the learning DB 113 along with the behavior result of the target customer.

The sales information DB 111 stores the sales information that is information regarding products purchased by a customer that visited the store in the past. The sales information DB 111 classifies and stores products purchased by the customer who visited the store in the past, for each account. In addition, the sales information DB 111 stores the sales information in a state capable of identifying products simultaneously purchased in each account.

The sales information DB 111 stores and accumulates information regarding products purchased by a customer each time the customer who visits the store newly purchases products, in other words, each time the customer who visits the store accounts products.

The sales information that is stored in the sales information DB 111 will be described in a later section in connection with a specific example.

The product position information DB 112 stores information regarding a position where each product is displayed in the store.

For example, the product position information DB 112 divides the store into a plurality of areas, display racks, or the like, and stores each area or each display rack and a product that is displayed in each area or each display rack, in correlation with each other. The product position information DB 112 may set coordinate axes (for example, x axis and y axis) in the store and may manage a position where each product is displayed in the store, with coordinates.

The learning DB 113 stores, as the training data of the learning model 105a, information regarding a behavior of a customer in a case where a product is recommended to the customer who did shopping in the past. Specifically, for the customer who did shopping in the past, the learning DB 113 stores a product recommended to the customer, a behavior of the customer after the product is recommended, information (shopping basket information) regarding a product input into the shopping basket by the customer, and information (customer information) regarding the customer in correlation with one another. In the following description, information that is stored as the training data of the learning model 105a in the learning DB 113 may be described as learning data.

In a case where the behavior recording unit 108 newly acquires the behavior result of the target customer to which the recommended product is recommended, the learning DB 113 stores information regarding the behavior result.

The learning data that is stored in the learning DB 113 may include data acquired in another store that is not a target of specifying a recommended product, in addition to data acquired in the store that is a target of specifying a recommended product to be recommended to the target customer with the information processing apparatus 10.

Processing by Purchase Product Prediction Unit 104

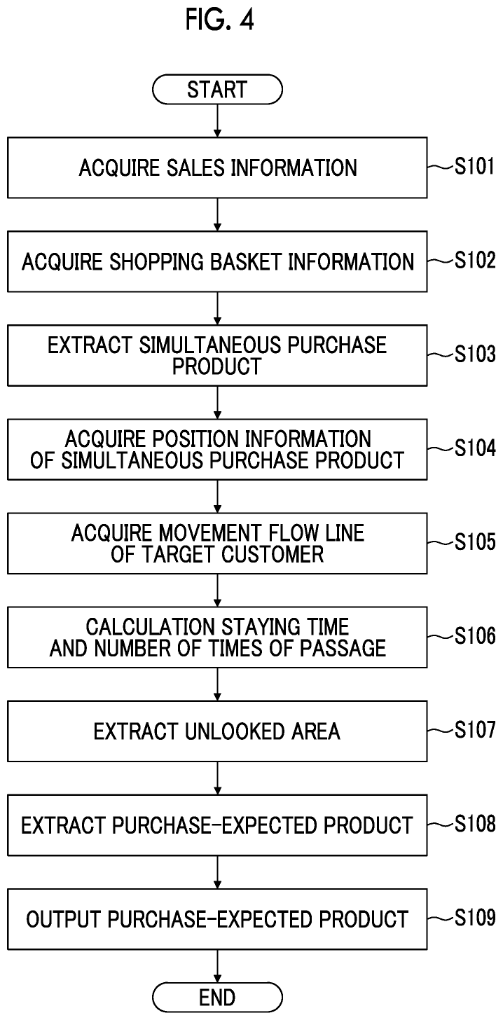

Subsequently, processing by the purchase product prediction unit 104 of the information processing apparatus 10 will be described. FIG. 4 is a flowchart illustrating an example of processing by the purchase product prediction unit 104 of the information processing apparatus 10 to which the present exemplary embodiment is applied.

First, the purchase product prediction unit 104 acquires sales information of products in a store from the sales information DB 111 (Step S101).

Next, the purchase product prediction unit 104 acquires shopping basket information that is information regarding a product put into the shopping basket by the target customer, from the basket information acquisition unit 101 (Step S102).

Next, the purchase product prediction unit 104 extracts other products that are purchased by a customer who did shopping in the store in the past, simultaneously with the product put into the shopping basket by the target customer, based on the sales information acquired in Step S101 and the shopping basket information acquired in Step S102 (Step S103). Hereinafter, other products that are extracted by the purchase product prediction unit 104 in Step S103 and are purchased by the customer who did shopping in the store in the past, simultaneously with the product put into the shopping basket by the target customer may be described as simultaneous purchase products.

Next, the purchase product prediction unit 104 acquires the position information in the store of the simultaneous purchase products extracted in Step S103 from the product position information DB 112 (Step S104). In this example, the purchase product prediction unit 104 acquires an area where each of the simultaneous purchase products is displayed in the store, as the position information in the store of the simultaneous purchase products extracted in Step S103.

Next, the purchase product prediction unit 104 acquires the movement flow line of the target customer from the flow line information acquisition unit 103 (Step S105).

Then, the purchase product prediction unit 104 calculates a staying time for which the target customer stays in each area in the store and the number of times of passage in which the target customer passes through each area in the store, based on the movement flow line of the target customer acquired in Step S105 (Step S106).

Next, the purchase product prediction unit 104 extracts an area where the target customer does not look displayed products in the store, based on the movement flow line of the target customer acquired in Step S105, and the staying time for which the target customer stays in each area in the store and the number of times of passage in which the target customer passes through each area in the store, calculated in Step S106 (Step S107).

Here, in Step S107, the purchase product prediction unit 104 may extract an area where the number of times of passage or the staying time is less than a predetermined reference while the target customer passes, as an area not looked by the target customer, in addition to an area where the target customer does not pass in the store.

Next, the purchase product prediction unit 104 extracts a purchase-expected product that is a product likely to be purchased by the target customer, from among the simultaneous purchase products extracted in Step S103 (Step S108). Specifically, the purchase product prediction unit 104 extracts, as the purchase-expected product, one or a plurality of products displayed in the area not looked by the target customer extracted in Step S107 from among the simultaneous purchase products extracted in Step S103 based on the position information of the simultaneous purchase products acquired in the Step S104.

Then, the purchase product prediction unit 104 outputs the extracted purchase-expected products to the behavior prediction unit 105 (Step S109), and ends the series of processing.

Processing by Behavior Prediction Unit 105

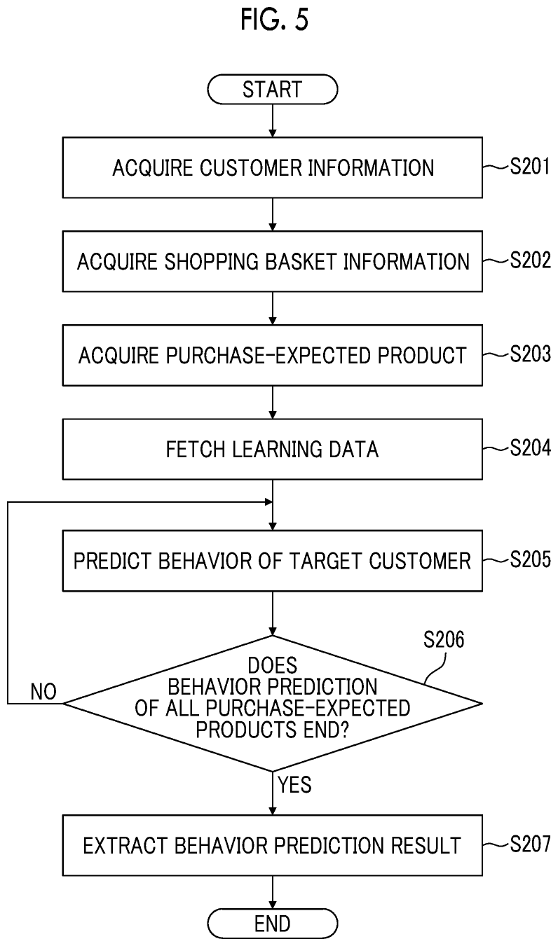

Subsequently, processing by the behavior prediction unit 105 of the information processing apparatus 10 will be described. FIG. 5 is a flowchart illustrating an example of processing of the behavior prediction unit 105 of the information processing apparatus 10 to which the present exemplary embodiment is applied.

First, the behavior prediction unit 105 acquires customer information that is information regarding the target customer, from the customer information acquisition unit 102 (Step S201).

Next, the behavior prediction unit 105 acquires shopping basket information that is information regarding the product put into the shopping basket by the target customer, from the basket information acquisition unit 101 (Step S202).

Next, the behavior prediction unit 105 acquires information regarding the purchase-expected product extracted in the purchase product prediction unit 104 (Step S203).

Next, the behavior prediction unit 105 fetches learning data stored in the learning DB 113 to the learning model 105a (Step S204).

Next, in regard to one purchase-expected product of the purchase-expected products acquired in Step S203, the behavior prediction unit 105 predicts a behavior of the target customer in a case where the purchase-expected product is recommended to the target customer, with the learning model 105a (Step S205).

Specifically, the behavior prediction unit 105 inputs, to the learning model 105a, the customer information acquired in Step S201, the shopping basket information acquired in Step S202, and one purchase-expected product of the purchase-expected products acquired in Step S203. The learning model 105a outputs a prediction result of a behavior of the target customer in a case where one purchase-expected product is recommended to the target customer, based on the input information and the learning data fetched in Step S204.

Though details will be described below, the learning model 105a outputs one of a plurality of predetermined classifications to which the predicted behavior of the target customer corresponds, as the prediction result of the behavior of the target customer. For example, the learning model 105a outputs any one of “purchase recommended purchase-expected product”, “purchase product other than recommended purchase-expected product”, or “purchase no product” to which the prediction result of the behavior of the target customer corresponds.

Next, the behavior prediction unit 105 determines whether or not the processing of Step S205 of predicting a behavior of the target customer is executed on all purchase-expected products acquired in Step S203 (Step S206). In a case where there is a purchase-expected product that is not subjected to the processing of Step S205 (in Step S206, NO), the behavior prediction unit 105 returns to Step S205 and continues the processing.

On the other hand, in a case where the processing of Step S205 is executed on all purchase-expected products (in Step S206, YES), in regard to each purchase-expected product, the behavior prediction unit 105 outputs the prediction result of the behavior of the target customer in a case where the purchase-expected product is recommended to the target customer, to the recommended product decision unit 106 (Step S207).

With the above, the series of processing by the behavior prediction unit 105 ends.

Processing by Recommended Product Decision Unit 106

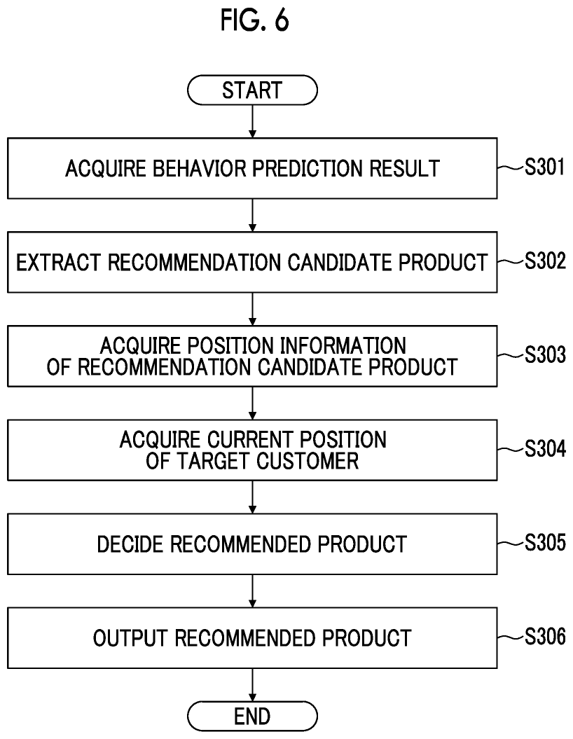

Subsequently, processing by the recommended product decision unit 106 of the information processing apparatus 10 will be described. FIG. 6 is a flowchart illustrating an example of processing of the recommended product decision unit 106 of the information processing apparatus 10 to which the present exemplary embodiment is applied.

First, the recommended product decision unit 106 acquires the prediction result of the behavior of the target customer in a case where the purchase-expected product is recommended to the target customer, from the behavior prediction unit 105 (Step S301).

Next, the recommended product decision unit 106 extracts purchase-expected products for which the prediction result of the behavior of the target customer corresponds to a desired classification, as recommendation candidate products from the purchase-expected products based on the prediction result acquired in Step S301 (Step S302).

Specifically, the recommended product decision unit 106 extracts the purchase-expected products for which the prediction result of the behavior of the target customer in a case where the purchase-expected product is recommended to the target customer corresponds to “purchase recommended purchase-expected product” or “purchase product other than recommended purchase-expected product”, as the recommendation candidate products from among the purchase-expected products.

Next, the recommended product decision unit 106 acquires position information in the store of the recommendation candidate products extracted in Step S302 from the product position information DB 112 (Step S303).

Next, the recommended product decision unit 106 acquires a current position of the target customer from the flow line information acquisition unit 103 (Step S304).

Next, the recommended product decision unit 106 decides a recommended product that is recommended to the target customer, from among the recommendation candidate products based on the position information of the recommendation candidate product acquired in Step S303 and the current position of the target customer acquired in Step S304 (Step S305).

Specifically, the recommended product decision unit 106 decides, as the recommended product, a product displayed at a position near the current position of the target customer in the store from among the recommendation candidate products extracted in Step S302.

Next, the recommended product decision unit 106 outputs information regarding the recommended product decided in Step S305 to the advertisement output unit 107 (Step S306), and ends the series of processing.

Thereafter, the advertisement output unit 107 that acquires information regarding the recommended product from the recommended product decision unit 106 outputs an advertisement for recommending the recommended product to the target customer to the terminal apparatus 20 of the target customer or the display 30. With this, the advertisement of the recommended product is displayed on the terminal apparatus 20 or the display 30.

### Specific Example of Processing by Information Processing Apparatus 10

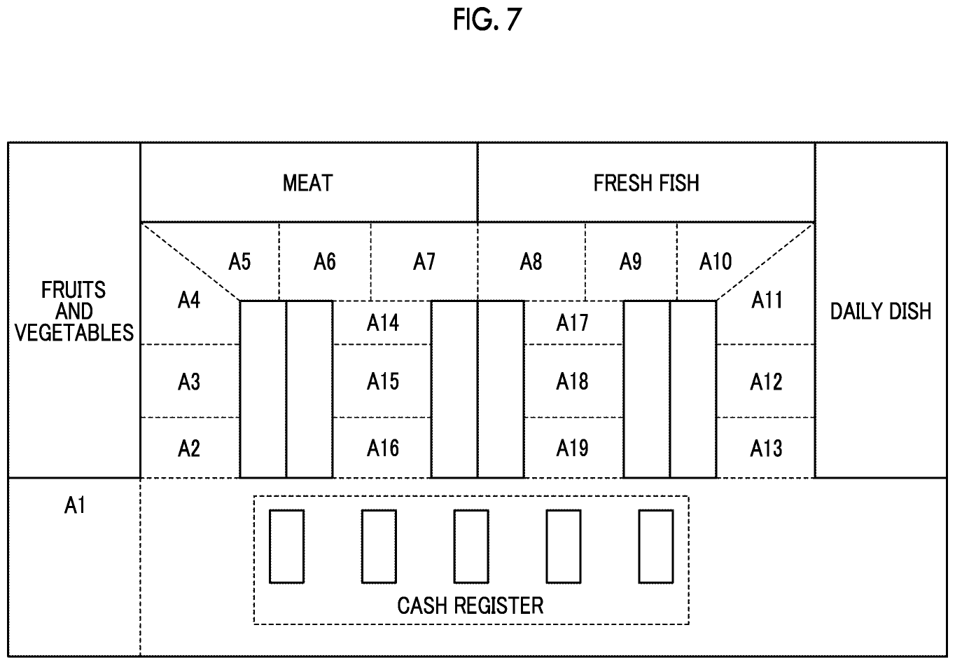

Subsequently, processing by the information processing apparatus 10 that recommends a product displayed in the store to the target customer who visits the store will be described using a specific example. FIG. 7 is a diagram showing an example of a store where the information processing apparatus 10 recommends a product to a customer. Here, description will be provided with a store that has one floor and deals in foodstuffs, such as a supermarket, as an example.

In the example shown in FIG. 7, in regard to the position information in the store, the information processing apparatus 10 divides and manages a passageway that faces display racks where products are displayed and through which a customer who visits the store passes, into 19 areas indicated by reference numerals A1 to A19.

The information processing apparatus 10 executes processing of recommending a product displayed in the store to the target customer who visits the store at a predetermined timing. Examples of the timing at which the information processing apparatus 10 executes the processing of recommending a product include a timing at which the target customer who visits the store puts a product displayed in the store into the shopping basket, a timing at which the target customer approaches the display 30 installed in the store, and a timing at which the target customer approaches a predetermined area or display rack in the store, but the timing is not particularly limited. The information processing apparatus 10 may execute the processing of recommending a product regularly at predetermined time intervals.

In the information processing apparatus 10, first, the purchase product prediction unit 104 acquires the sales information from the sales information DB 111 (Step S101 described above; the same applies to the following).

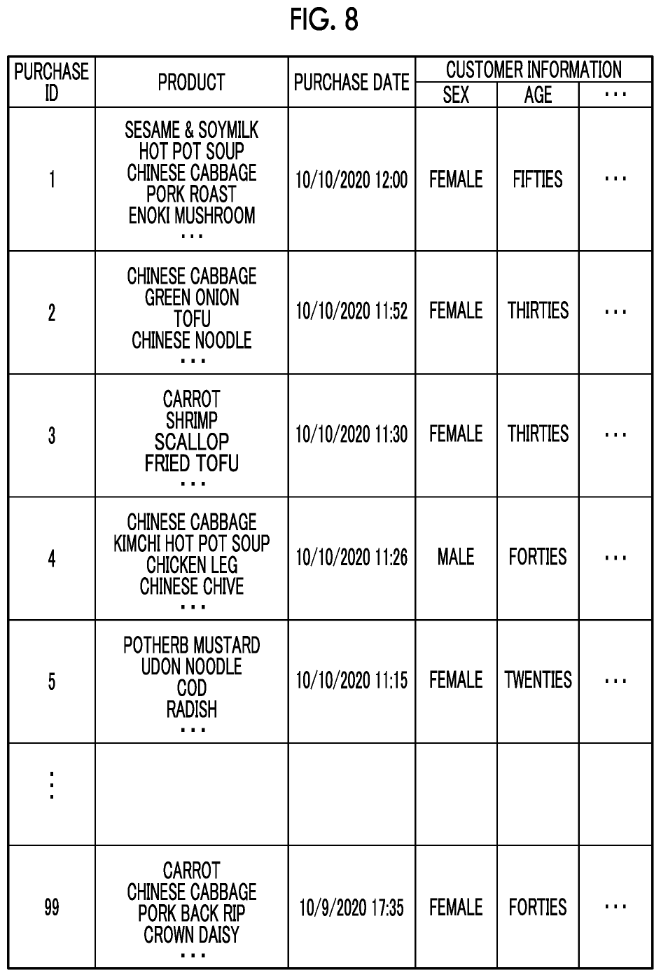

FIG. 8 is a diagram showing an example of the sales information that is stored in the sales information DB 111 and is acquired by the purchase product prediction unit 104.

As shown in FIG. 8, the sales information DB 111 classifies and stores the sales information regarding products purchased by a customer who visited the store in the past, by a purchase ID for each account. For example, in the sales information classified by a purchase ID1, a female customer in her fifties simultaneously purchases sesame & soymilk hot pot soup, Chinese cabbage, pork roast, enoki mushroom, and the like as products at 12:00 on Oct. 10, 2020.

Next, in the information processing apparatus 10, the basket information acquisition unit 101 identifies the products put into the shopping basket by the target customer who visits the store and acquires the shopping basket information that is information regarding the products put into the shopping basket. Then, the purchase product prediction unit 104 acquires the shopping basket information from the basket information acquisition unit 101 (Step S102).

In this example, it is assumed that the target customer who visits the store passes through the area A1 to the area A4 where fruits and vegetables are displayed, in the store in order, puts Chinese cabbage, green onion, and carrot into the shopping basket in the area A2, and puts potherb mustard into the shopping basket in the area A3. In this case, the purchase product prediction unit 104 acquires information indicating that Chinese cabbage, green onion, carrot, and potherb mustard are put into the shopping basket, as the shopping basket information.

Next, in the information processing apparatus 10, the purchase product prediction unit 104 extracts simultaneous purchase products that are other products purchased by a customer who did shopping in the store in the past, simultaneously with the products put into the shopping basket by the target customer, based on the sales information and the shopping basket information (Step S103).

In this example, the purchase product prediction unit 104 extracts simultaneous purchase products that are purchased by the customer who did shopping in the store in the past, simultaneously with Chinese cabbage, green onion, carrot, and potherb mustard, based on the sales information shown in FIG. 8. Specifically, the purchase product prediction unit 104 extracts, as the simultaneous purchase products, sesame & soymilk hot pot soup, pork roast, enoki mushroom, tofu, Chinese noodle, shrimp, scallop, fried tofu, kimchi hot pot soup, chicken leg, Chinese chive, udon noodle, cod, radish, pork back rip, crown daisy, and the like.

Next, in the information processing apparatus 10, the purchase product prediction unit 104 acquires the position information of each of the simultaneous purchase products extracted in Step S103 from the product position information DB 112 (Step S104).

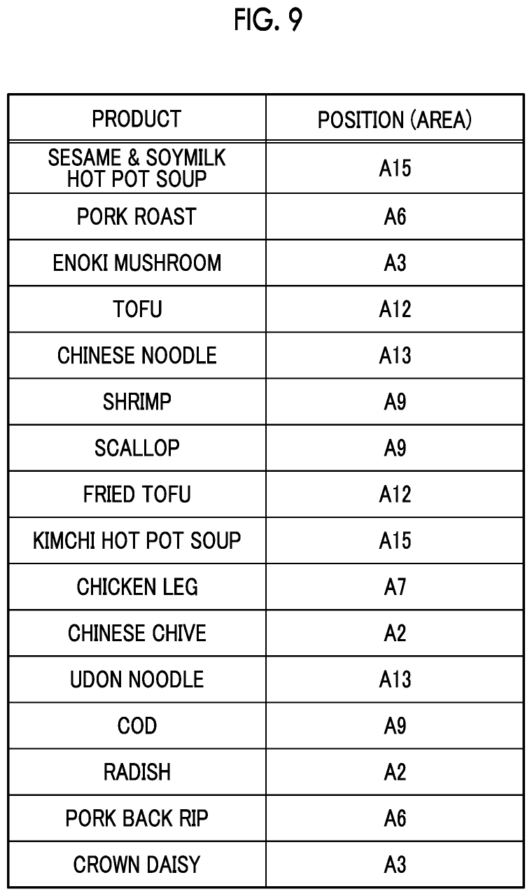

FIG. 9 is a diagram showing an example of the position information of the simultaneous purchase products that are acquired from the product position information DB 112 by the purchase product prediction unit 104.

As shown in FIG. 9, the purchase product prediction unit 104 acquires an area where the each of the simultaneous purchase products is displayed in the store, as the position information of the simultaneous purchase product.

Next, in the information processing apparatus 10, the purchase product prediction unit 104 acquires the movement flow line of the target customer from the flow line information acquisition unit 103 (Step S105), and calculates the staying time for which the target customer stays in each area in the store and the number of times of passage in which the target customer passes through each area in the store (Step S106).

Then, in the information processing apparatus 10, the purchase product prediction unit 104 extracts an area where the target customer does not look products in the store based on the movement flow line of the target customer, the number of times of passage where the target customer passes through each area in the store, and the staying time for which the target customer stays in each area in the store (Step S107). Specifically, the purchase product prediction unit 104 extracts an area where the number of times of passage is less than a predetermined reference number of times (in this example, once), as the area where the target customer does not look products. The purchase product prediction unit 104 extracts an area where the staying time is equal to or shorter than a predetermined reference time, among areas where the number of times of passage is equal to or greater than the reference number of times, as the area not looked by the target customer.

In this example, the target customer visits the area A1 to the area A4 of the store, but does not yet visit the area A5 to the area A19. In other words, the number of times of passage in which the target customer passes through each area is one for the area A1 to the area A4, and is zero for the area A5 to the area A19. The target customer simply passes by the area A1 and the area A4 among the visited area A1 to area A4, and the staying time in the area A1 and the area A4 is very short.

Accordingly, the purchase product prediction unit 104 extracts the area A5 to the area A19 where the number of times of passage of the target customer is less than the reference number of times and the area A1 and the area A4 where the staying time of the target customer is less than the reference time, among the area A1 to the area A19 in the store as the area where the target customer does not look products.

Next, in the information processing apparatus 10, the purchase product prediction unit 104 extracts one or a plurality of products displayed in the area not looked by the target customer extracted in Step S107 from among the simultaneous purchase products extracted in Step S103 as the purchase-expected products (Step S108), and outputs the purchase-expected products to the behavior prediction unit 105 (Step S109).

In this example, the purchase product prediction unit 104 extracts, as the purchase-expected products, pork roast and pork back rip displayed in the area A6, chicken leg displayed in the area A7, shrimp, scallop, and cod displayed in the area A9, tofu and fried tofu displayed in the area A12, Chinese noodle and udon noodle displayed in the area A13, sesame & soymilk hot pot soup and kimchi hot pot soup displayed in the area Aly as an area where the target customer does not look products.

On the other hand, the purchase product prediction unit 104 does not extract, as the purchase-expected products, Chinese chive and radish displayed in the area A2 and enoki mushroom and crown daisy displayed in the area A3 as an area where the target customer already looks products.

Next, in the information processing apparatus 10, the behavior prediction unit 105 acquires the customer information that is information regarding the target customer, from the customer information acquisition unit 102 (Step S201), and acquires the shopping basket information from the basket information acquisition unit 101 (Step S202). In this example, the behavior prediction unit 105 acquires the sex (for example, female) of the target customer and the age (for example, forties) of the target customer as the customer information.

In the information processing apparatus 10, the behavior prediction unit 105 acquires information regarding the purchase-expected products extracted by the purchase product prediction unit 104 (Step S203).

Next, in the information processing apparatus 10, the behavior prediction unit 105 fetches the learning data to the learning model 105a (Step S204). Then, the behavior prediction unit 105 predicts the behavior of the target customer in a case where each purchase-expected product is recommended to the target customer, using the learning model 105a (Step S205 and Step S206).

In this example, the learning model 105a predicts the behavior of the target customer in a case where each purchase-expected product is recommended to the target customer, based on the shopping basket information and the customer information with the learning data fetched from the learning DB 113 as training data, and outputs a prediction result. In addition, the learning model 105a predicts any one of “purchase recommended purchase-expected product”, “purchase product other than recommended purchase-expected product”, or “not purchase recommended purchase-expected product” to which the behavior of the target customer in a case where each purchase-expected product is recommended to the target customer corresponds, and outputs a prediction result.

Specifically, the learning model 105a extracts a behavior result on a customer who has the customer information identical to the target customer and purchases a product identical to the product put into the shopping basket by the target customer, from the learning data based on the customer information and the shopping basket information. More specifically, the learning model extracts a behavior result on a customer who is a female in her forties identical to the target customer and purchases Chinese cabbage, green onion, carrot, or potherb mustard put into the shopping basket by the target customer, from the learning data.

Then, the learning model predicts any one of “purchase recommended purchase-expected product”, “purchase product other than recommended purchase-expected product”, or “not purchase recommended purchase-expected product” to which the behavior of the target customer in a case where the purchase-expected product is recommended to the target customer corresponds, with the behavior result extracted from the learning data as training data.

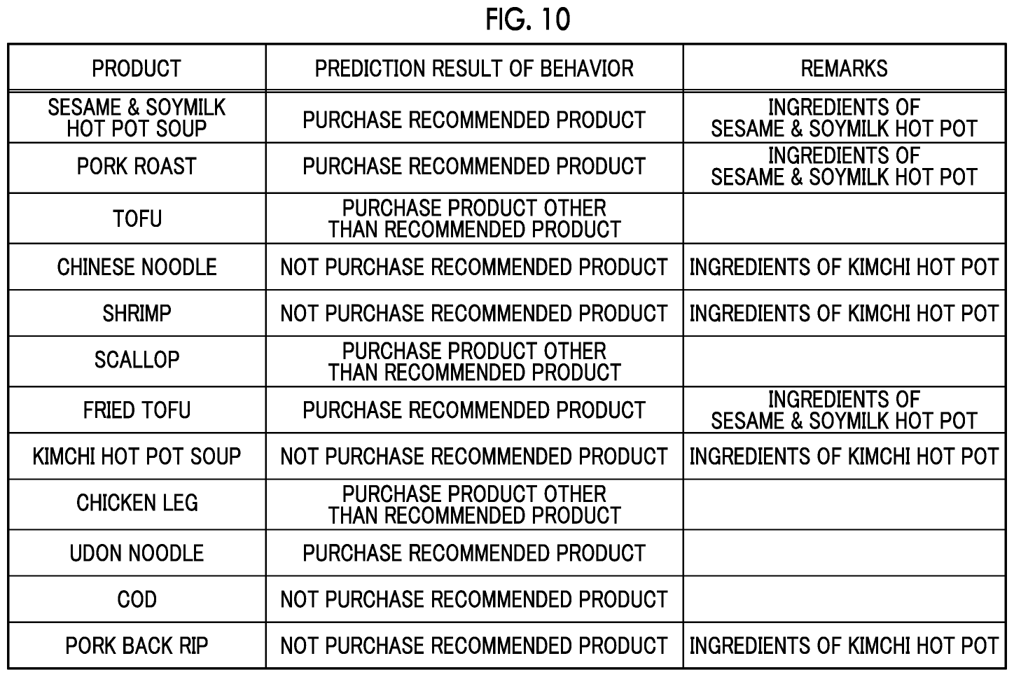

FIG. 10 is an example of a prediction result of the behavior of the target customer in a case where a purchase-expected product is recommended to the target customer, output from the learning model 105a.

A case of predicting the behavior of the target customer in a case where “sesame & soymilk hot pot soup” that is one of the purchase-expected products is recommended to the target customer is considered. In this example, it is assumed that an example of, in a case where sesame & soymilk hot pot soup is recommended to a customer who did shopping in the store in the past, “purchased recommended product (sesame & soymilk hot pot soup)” as the behavior of the customer is more stored in, for example, the learning data, than an example of “purchased product other than recommended product”, or “not purchased any product”. In this case, the learning model 105a predicts “purchase recommended product” as the behavior of the target customer in a case where sesame & soymilk hot pot soup is recommended to the target customer, based on the learning data.

A case of predicting the behavior of the target customer in a case where “kimchi hot pot soup” that is one of the purchase-expected products is recommended to the target customer is considered. In this example, it is assumed that an example of, in a case where kimchi hot pot soup is recommended to a customer who did shopping in the store in the past, “not purchased any product” as the behavior of the customer is more stored in, for example, learning data than an example of “purchased recommended product (kimchi hot pot soup)” or “purchased product other than recommended product”. In this case, the learning model 105a predicts “not purchase recommended product” as the behavior of the target customer in a case where kimchi hot pot soup is recommended to the target customer, based on the learning data.

Here, the learning model 105a may limit the learning data that is used as training data, based on the customer information in a case of predicting the behavior of the target customer. In addition, the learning model 105a extracts a behavior result on a customer who has the customer information close to the target customer, from the behavior results stored as the learning data of the customers who did shopping in the store in the past, based on the acquired customer information. For example, the learning model 105a extracts a behavior result on a customer who has the sex and the age identical to the target customer, from the learning data. Then, the learning model 105a predicts the behavior of the target customer in a case where the purchase-expected product is recommended to the target customer, based on the extracted behavior result of the customer.

With this, the behavior of the target customer is easily predicted with accuracy compared to a case where the learning data that is used as training data is not limited based on the customer information.

Alternatively, the learning model 105a may predict the behavior of the target customer using, for example, a recipe or the like using the purchase-expected products, in addition to the behavior of the customer who did shopping in the store in the past, stored as the learning data.

Specifically, in a case where “purchase recommended product” is predicted as the behavior of the target customer in a case where sesame & soymilk hot pot soup that is one of the purchase-expected products is recommended to the target customer, in regard to other purchase-expected products of pork roast, fried tofu, udon noodle, and the like as the ingredients of sesame & soymilk hot pot, the learning model 105a predicts “purchase recommended product” as the behavior of the target customer in a case of being recommended to the target customer, based on a recipe of a dish “sesame & soymilk hot pot” using sesame & soymilk hot pot soup.

On the other hand, in a case where “not purchase recommended product” is predicted as the behavior of the target customer in a case where kimchi hot pot soup that is one of the purchase-expected products is recommended to the target customer, in regard to other purchase-expected products of pork back rip, shrimp, Chinese noodle, and the like as the ingredients of kimchi hot pot, the learning model 105a predicts “not purchase recommended product” as the behavior of the target customer in a case of being recommended to the target customer, based on a recipe of a dish “kimchi hot pot” using kimchi hot pot soup.

Next, in the information processing apparatus 10, in regard to each of the purchase-expected products, the behavior prediction unit 105 outputs a prediction result of the behavior of the target customer in a case where the purchase-expected product is recommended to the target customer, to the recommended product decision unit 106 (Step S207).

Next, in the information processing apparatus 10, the recommended product decision unit 106 acquires the prediction result of the behavior of the target customer in a case where the purchase-expected product is recommended to the target customer, output from the behavior prediction unit 105 (Step S301).

Then, in the information processing apparatus 10, the recommended product decision unit 106 extracts, as recommendation candidate products, the purchase-expected products for which the prediction result of the behavior of the target customer corresponds to a desired classification, from among the purchase-expected product based on the acquired prediction result (Step S302).

In this example, the recommended product decision unit 106 extracts, as the recommendation candidate products, the purchase-expected products for which “purchase recommended (purchase-expected) product” and “purchase product other than recommended (purchase-expected) product” are predicted as the behavior of the target customer, from among the purchase-expected products. More specifically, the recommended product decision unit 106 extracts, as the recommendation candidate products, sesame & soymilk hot pot soup, pork roast, fried tofu, and udon noodle for which “purchase recommended (purchase-expected) product” is predicted as the behavior of the target customer, and tofu, scallop, and chicken leg for which “purchase product other than recommended (purchase-expected) product” is predicted as the behavior of the target customer, from among the purchase-expected products.

Next, in the information processing apparatus 10, the recommended product decision unit 106 acquires the position information in the store of the recommendation candidate products extracted in Step S302 from the product position information DB 112 (Step S303), and acquires the current position of the target customer from the flow line information acquisition unit 103 (Step S304).

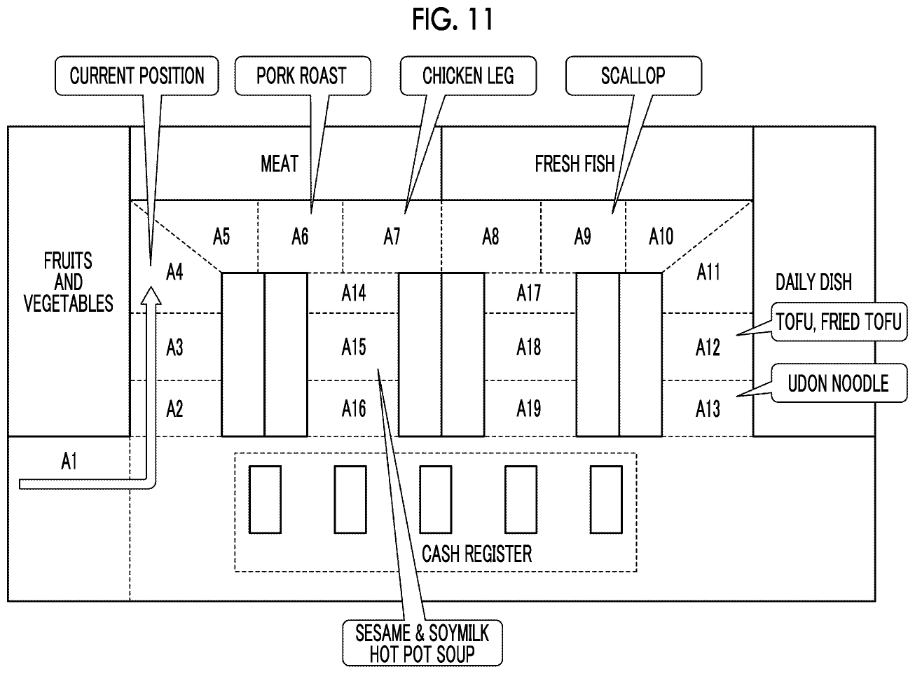

FIG. 11 is a diagram showing a relationship between the position information in the store of the recommendation candidate products and the current position of the target customer.

Next, in the information processing apparatus 10, the recommended product decision unit 106 decides, as a recommended product, a product displayed in an area near the current position of the target customer from among the recommendation candidate products extracted in Step S302 (Step S305), and outputs the recommended product to the advertisement output unit 107 (Step S306).

In this example, as shown in FIG. 11, the recommended product decision unit 106 decides, as recommended products, pork roast displayed in the area A6 and sesame & soymilk hot pot soup displayed in the area A15 near the area A4 as the current position of the target customer.

In this example, although the recommended product decision unit 106 decides two products of pork roast and sesame & soymilk hot pot soup as the recommended product, the number of recommended products is not particularly limited and may be one or may be plural to be equal to or greater than three. The recommended product decision unit 106 may the number of recommended products, for example, depending on the number of advertisements that can be displayed on the terminal apparatus 20 or the display 30.

Next, in the information processing apparatus 10, the advertisement output unit 107 displays advertisements for recommending the recommended products of pork roast and sesame & soymilk hot pot soup to the target customer on the terminal apparatus 20 and the display 30.

Thereafter, in a case where the target customer moves in the store and newly puts another product displayed in the store into the shopping basket, the information processing apparatus 10 executes the above-described processing again, acquires the shopping basket information or information regarding the movement flow line, the current position, or the like of the target customer, and specifies a recommended product again. With this, recommended products depending on the situation of the target customer in the store are specified, and recommended products highly likely to be purchased by a customer are easily specified.

Next, after the information processing apparatus 10 displays the advertisements of the recommended products on the terminal apparatus 20 and the display 30, the behavior recording unit 108 acquires the behavior of the target customer. The behavior recording unit 108 acquires the behavior of the target customer, for example, at a timing at which the target customer performs the account of the products or the like put into the shopping basket. Then, the behavior recording unit 108 stores the acquired behavior of the target customer in the learning DB 113.

Here, examples of the behavior of the target customer include classifications of “purchased recommended product (sesame & soymilk hot pot soup)”, “purchased product other than recommended product”, and “not purchased any product”.

The behavior recording unit 108 may include information regarding whether or not the target customer is induced by the advertisement, as the behavior of the target customer. In addition, the behavior recording unit 108 may divide the behavior of the target customer into classifications “be induced by advertisement and purchased recommended product”, “be induced by advertisement and purchased product other than recommended product”, “be induced by advertisement, but not purchased any product”, and “be not induced by advertisement”, and may store the behavior of the target customer in the learning DB 113.

For example, in this example, in a case where the advertisement of the recommended product of sesame & soymilk hot pot soup is displayed on the terminal apparatus 20 and the like, and in a case where the target customer moves to the area A15 where sesame & soymilk hot pot soup is displayed and purchases sesame & soymilk hot pot soup, the behavior recording unit 108 stores “be induced by advertisement and purchased recommended product” in the learning DB 113. In a case where the target customer moves to the area A15 where sesame & soymilk hot pot soup is displayed and purchases kimchi hot pot soup that is not the recommended product, the behavior recording unit 108 stores “be induced by advertisement and purchased product other than recommended product” in the learning DB 113. In a case where the target customer moves to the area A15 where sesame & soymilk hot pot soup is displayed, but does not purchase any product, the behavior recording unit 108 stores “be induced by advertisement, but not purchased any product” in the learning DB 113. In a case where the target customer does not move to the area A15 where sesame & soymilk hot pot soup is displayed, the behavior recording unit 108 stores “be not induced by advertisement” in the learning DB 113.

As described above, in the product recommendation system 1 of the present exemplary embodiment, the recommended product is specified from among the products displayed at a place not looked by the target customer using the movement flow line of the target customer in the store with the information processing apparatus 10.

With this, a situation in which a product already determined to be looked and not purchased by the target customer is recommended to the target customer again is suppressed. As a result, a product highly likely to be purchased by the target customer is easily specified as the recommended product that is recommended to the target customer, compared to a case where the movement flow line of the target customer in the stored is not used.

In the product recommendation system 1 of the present exemplary embodiment, the recommended product specified from among the products displayed at a place not looked by the target customer is recommended to the target customer, whereby the target customer is easily induced to a place not looked by the target customer in the store. Here, in the store where the products are displayed, as the staying time in the store is longer, a purchase price of products purchased by a customer who visits the store tends to increase. In the present exemplary embodiment, the target customer is induced to a place not looked by the target customer in the store, whereby the staying time of the target customer in the store is extended, and a purchase price of products of the target customer is easily increased.

In the product recommendation system 1 of the present exemplary embodiment, a product near the current position of the target customer is specified as the recommended product from among the recommendation candidate products with the information processing apparatus 10. With this, for example, the target customer to which the recommended product is recommended is easily induced to an area where the recommended product is displayed, and the target customer is highly likely to purchase the recommended product, compared to a case where the recommended product is specified without depending on the current position of the target customer.

The information processing apparatus 10 specifies the recommended product for which a predetermined behavior of the target customer is predicted, using the learning model 105a that learns a behavior in a case where another product is recommended to a customer who selects a certain product as a purchase target.

With this, a product highly likely to be purchased by the target customer is more easily specified, compared to a case where the recommended product is specified without using the learning model 105a.

Here, in the above-described example, in the information processing apparatus 10, the recommended product decision unit 106 decides a plurality of products as the recommended products. In a case where a plurality of products are decided as the recommended products, the information processing apparatus 10 may differ priority for recommendation to the target customer among a plurality of recommended products. In this case, the advertisement output unit 107 may display the advertisements of a plurality of recommended products on the terminal apparatus 20 or the display 30 in different aspects depending on the priority of the recommended products. With this, the recommended product with higher priority among the recommended products is made to be easily purchased by the target customer.

In this case, it is preferable that the information processing apparatus 10 gives high priority to a recommended product displayed at a predetermined specific place in the store, for example. Specifically, in the information processing apparatus 10, the recommended product decision unit 106 gives high priority to a recommended product displayed at a place hardly visited by a customer who visits the store as a specific place. In this case, the target customer is easily induced to a place hardly visited by a customer who visits the store.

For example, in the store shown in FIG. 7, the area A1 to the area A13 are a passageway through which the customers who visit the store mostly pass, and are easily visited by the customers. On the other hand, the area A14 to the area A19 tend to be hardly visited by the customers who visit the store. In such a case, the recommended product decision unit 106 of the information processing apparatus 10 gives higher priority to sesame & soymilk hot pot soup displayed in the area Aly among the area A14 to the area A19 than pork roast as the recommended product displayed in the area A6 among the area A1 to the area A13.

The information processing apparatus 10 may give priority to a recommended product displayed at a place where products particularly desired to be sold in the store, such as sale products, as a specific place.

It is preferable that the information processing apparatus 10 gives high priority to a recommended product decided based on a product selected later among the products selected as the purchase target by the target customer, among a plurality of recommended products, for example. With this, a recommended product matching the present situation of the target customer who selects a product as the purchase target is easily specified, and the recommended product is made to be easily purchased by the target customer.

Specifically, in the information processing apparatus 10, the basket information acquisition unit 101 acquires, as the shopping basket information, information regarding an order in which the products are put into the shopping basket, in addition to information for identifying the products put into the shopping basket. Then, the recommended product decision unit 106 of the information processing apparatus 10 gives higher priority to a recommended product decided based on a product put into the shopping basket by the target customer later among a plurality of recommended products based on the shopping basket information.

In the above description, although a supermarket having one floor has been described as an example of the store, the store is not limited thereto. The store may have, for example, a plurality of floors or a plurality of buildings.

The store may be a shopping center or the like including a plurality of counters each of which displays products and performs the account. In this case, for example, the information processing apparatus 10 may set a product accounted and purchased by the target customer in each counter as “a product selected as a purchase target by a customer”, and may specify the above-described purchase-expected products from among products displayed in a counter not looked by the target customer in the store, based on the product.

In the above-described product recommendation system. 1, although the advertisement output unit 107 displays the advertisement of the recommended product on the terminal apparatus 20 or the display 30, thereby recommending the recommended product to the target customer, a recommendation method of the recommended product is not limited thereto. The advertisement output unit 107 may recommend a product to the target customer by voice, for example, using a speaker or the like installed in the store.

The advertisement of the recommended product output from the advertisement output unit 107 may be a form in which the recommended product is indirectly recognized by the target customer using, for example, a recipe or the like of a dish using the recommended product, in addition to a form in which the recommended product is directly recognized by the target customer using a product name of the recommended product.

Although the exemplary embodiment has been described above, the technical scope of the invention is not limited to the above-described exemplary embodiment. It is apparent from the scope of the claims that exemplary embodiments with various alterations or improvements are included in the technical scope of the invention.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
specify, using information regarding a product selected as a purchase target by an in-store customer who visits a store and a movement flow line of the in-store customer in the store, a recommended product to be recommended to the in-store customer from among products displayed at a place not looked by the in-store customer in the store.

2. The information processing apparatus according to claim 1, wherein the processor is configured to:
input the information regarding the product selected as the purchase target by the in-store customer and information regarding the products displayed at the place not looked by the in-store customer to a learning model that learns a behavior in a case where another product is recommended to a customer who selects a certain product as a purchase target, and
specify the recommended product that the in-store customer is predicted to show a predetermined behavior in a case of being recommended to the in-store customer, from among the products displayed at the place not looked by the in-store customer.

3. The information processing apparatus according to claim 2,
wherein the learning model learns a relationship between information regarding the customer who selects the certain product as the purchase target and the behavior in a case where the other product is recommended, and
the processor is configured to:
further input information regarding the in-store customer to the learning model and specify the recommended product based on the information regarding the in-store customer.

4. The information processing apparatus according to claim 2, wherein the processor is configured to:
specify a product likely to be purchased by the in-store customer from among the products displayed at the place not looked by the in-store customer using the information regarding the product selected as the purchase target by the in-store customer and the movement flow line of the in-store customer, and
input information regarding the product likely to be purchased by the in-store customer as the products displayed at the place not looked by the in-store customer, to the learning model.

5. The information processing apparatus according to claim 4, wherein the processor is configured to:
specify the product likely to be purchased by the in-store customer further using information regarding sales of the products in the store.

6. The information processing apparatus according to claim 2, wherein the processor is configured to:
make the learning model learn a behavior result of the in-store customer in a case where the recommended product is recommended to the in-store customer, as training data.

7. The information processing apparatus according to claim 1, wherein the processor is configured to:
specify the place not looked by the in-store customer based on a staying time of the in-store customer or the number of times of staying of the in-store customer at a place where each product is displayed, acquired based on the movement flow line.

8. The information processing apparatus according to claim 1, wherein the processor is configured to:
acquire a current position of the in-store customer in the store and specify, as the recommended product, a product displayed at a place near the current position of the in-store customer from among the products displayed at the place not looked by the in-store customer.

9. The information processing apparatus according to claim 1, wherein the processor is configured to:
specify a plurality of the recommended products with different priorities to be recommended to the in-store customer.

10. The information processing apparatus according to claim 9, wherein the processor is configured to:
give high priority to the recommended product displayed at a predetermined specific place in the store.

11. The information processing apparatus according to claim 9, wherein the processor is configured to:
give high priority higher to the recommended product specified using information regarding a product selected later among the products selected as the purchase target by the in-store customer.

12. A product recommendation system comprising:
an information processing apparatus that, using information regarding a product selected as a purchase target by an in-store customer who visits a store and a movement flow line of the in-store customer in the store, specifies a recommended product to be recommended to the in-store customer from among products displayed at a place not looked by the in-store customer in the store; and
an output device that outputs an advertisement on the recommended product specified by the information processing apparatus.

13. A non-transitory computer readable medium storing a program, the program causing a computer to realize:
a function of specifying, using information regarding a product selected as a purchase target by an in-store customer who visits a store and a movement flow line of the in-store customer in the store, a recommended product to be recommended to the in-store customer from among products displayed at a place not looked by the in-store customer in the store.
